(19) United States
(12) Patent Application Publication
(10) Pub. No.: US 2026/0159740 A1
(43) Pub. Date: Jun. 11, 2026

(54) AZEOTROPIC AND AZEOTROPE-LIKE COMPOSITIONS OF PERFLUOROHEPTENE AND FLUOROETHERS AND USES THEREOF

(71) Applicant: THE CHEMOURS COMPANY FC, LLC, WILMINGTON, DE (US)

(72) Inventors: MICHAEL R. FRASER, QUAKERTOWN, PA (US); HIDEAKI KIKUCHI, SHIZUOKA-SHI, SHIZUOKA (JP); RAYMOND WU, MOUNT LAUREL, NJ (US)

(73) Assignee: THE CHEMOURS COMPANY FC, LLC, WILMINGTON, DE (US)

(21) Appl. No.: 18/708,230

(22) PCT Filed: Nov. 22, 2022
(86) PCT No.: PCT/US2022/050719

§ 371 Date: May 8, 2024

Related U.S. Application Data
(60) Provisional application No. 63/282,572, filed on Nov. 23, 2021.

(51) Int. Cl. C09K 5/10; C11D 7/26; C11D 7/30

(52) U.S. Cl. CPC C09K 5/10; C11D 7/263; C11D 7/30

(57) ABSTRACT

The present disclosure provides azeotropic and azeotrope-like compositions comprised of perfluoroheptene and several fluoroethers. The present disclosure also provides for methods of use for the azeotropic and azeotrope-like compositions. Methods of use include removing a residue from the surface of an object, deposition of a lubricant on the surface of an object such a magnetic media device, and a method of cooling an electronic component comprising at least partially immersing an electrical component in a working fluid and transferring heat from the electrical component.

### CROSS REFERENCED TO RELATED APPLICATIONS

This application is a national stage filing under 35 U.S.C. 371 of International Application No. PCT/US2022/050719 filed Nov. 22, 2022, and claims the benefit of priority of U.S. Provisional Application 63/282,572 filed Nov. 23, 2021.

### BACKGROUND INFORMATION

### Field of the Disclosure

The present disclosure is in the field of perfluoroheptene compositions. These compositions are azeotropic or azeotrope-like and are useful in cleaning applications as a defluxing agent and for removing oils or residues from a surface.

### Description of the Related Art

Flux residues are always present on microelectronics components assembled using rosin flux. As modern electronic circuit boards evolve toward increased circuit and component densities, thorough board cleaning after soldering becomes a critical processing step. After soldering, the flux-residues are often removed with an organic solvent. De-fluxing solvents should be non-flammable, have low toxicity and have high solvency power, so that the flux and flux-residues can be removed without damaging the substrate being cleaned. For proper operation in use, microelectronic components must be cleaned of flux residues, oils and greases, and particulates that may contaminate the surfaces after completion of manufacture.

In cleaning apparatuses, including vapor degreasing and vapor defluxing equipment, compositions may be lost during operation through leaks in shaft seals, hose connections, soldered joints and broken lines. In addition, the working composition may be released to the atmosphere during maintenance procedures on equipment. If the composition is not a pure component, the composition may change when leaked or discharged to the atmosphere from the equipment, which may cause the composition remaining in the equipment to exhibit unacceptable performance. Accordingly, it is desirable to use a composition comprising a single unsaturated fluorinated ether as a cleaning composition.

Alternative, non-ozone depleting solvents have become available since the elimination of nearly all previous chlorofluorocarbons (CFCs) and hydrochlorofluorocarbons (HCFCs) as a result of the Montreal Protocol. While boiling point, flammability and solvent power characteristics can often be adjusted by preparing solvent mixtures, these mixtures are often unsatisfactory because they fractionate to an undesirable degree during use. Such solvent mixtures also fractionate during solvent distillation, which makes it virtually impossible to recover a solvent mixture of the original composition.

Many industries use aqueous compositions for the surface treatment of metals, ceramics, glasses, and plastics. Cleaning, plating, and deposition of coatings are often carried out in aqueous media and are usually followed by a step-in which residual water is removed. Hot air drying, centrifugal drying, and solvent-based water displacement are methods used to remove such residual water.

There is a need in the industry for improved methods for deposition of fluorolubricants. The use of certain solvents, such as CFC-113 and PFC-5060, has been regulated due to their impact on the environment. While hydrofluorocarbons (HFCs) have been proposed as replacements for the previously used CFC solvents in drying or dewatering applications, many HFCs have limited solvency for water. The use of surfactant, which assists in removal of water from substrates, is therefore necessary in many drying or dewatering methods. Hydrophobic surfactants have been added to dewatering or drying solvents to displace water from substrates.

The primary function of the dewatering or drying solvent (unsaturated fluorinated ether solvent) in a dewatering or drying composition is to reduce the amount of water on the surface of a substrate being dried. The primary function of the surfactant is to displace any remaining water from the surface of the substrate. When the unsaturated fluorinated ether solvent and surfactant are combined, a highly effective displacement drying composition is attained.

Solvents used for this purpose must dissolve the fluorolubricant and form a substantially uniform or uniform coating of fluorolubricant. Additionally, existing solvents have been found to require higher fluorolubricant concentrations to produce a given thickness coating and produce irregularities in uniformity of the fluorolubricant coating.

The most advanced, highest recording densities and lowest cost method of storing digital information involves writing and reading magnetic flux patterns from rotating disks coated with magnetic materials. A magnetic layer, where information is stored in the form of bits, is sputtered onto a metallic support structure. Next an overcoat, usually a carbon-based material, is placed on top of the magnetic layer for protection and finally a lubricant is applied to the overcoat. A read-write head flies above the lubricant and the information is exchanged between the head and the magnetic layer. The distance between the read-write head and the magnetic layer is less than 100 Angstroms.

Invariably, during normal disk drive application, the head and the disk surface will make contact. The disk is lubricated to reduce wear from sliding and flying contacts. Fluorolubricants are used as lubricants to decrease the friction between the head and disk, thereby reducing wear and minimizing the possibility of disk failure.

Azeotropic solvent mixtures may possess the properties needed for de-fluxing, de-greasing applications and other cleaning agent needs. Azeotropic mixtures exhibit either a maximum or a minimum boiling point and do not fractionate on boiling. The inherent invariance of composition under boiling conditions ensures that the ratios of the individual components of the mixture will not change during use and that solvency properties will remain constant as well.

The present disclosure provides azeotropic and azeotrope-like compositions useful in semiconductor chip and circuit board cleaning, defluxing, and degreasing processes. The present compositions are non-flammable, and as they do not fractionate, will not produce flammable compositions during use. Additionally, the used azeotropic solvent mixtures may be re-distilled and re-used without composition change.

Other applications opportunities for these new proposed working fluids exist in cooling power electronics (TVs, cell phones, monitors, drones, etc.) battery thermal management (automotive and stationary), e-powertrain, IGBT, computer server systems, 5G network, displays. Working fluids provide the medium to transport heat or in passive evaporative cooling such as heat pipes. Key factors to consider regarding the compatible use of these fluids include dielectric constant, dissipation factor or loss tangent, volumetric resistivity and dielectric strength and non-flammability. These factors provide for an envelope in which fluids in direct contact with electrically charged systems must exist to be non-conductive fluids. The molecules should also have structural properties that make it non-flammable, low GWP, and short atmospheric lifetime, i.e. a double bond. Several of the novel fluid mixtures described below have been identified by the inventors which meet all these requirements and meets the needs identified for this market.

Applications where this solution can be employed include the cooling of electronic devices-datacenter servers, insulated-gate bipolar transistor (IGBT) devices, telecommunication infrastructure, military electronics, televisions (TVs), cell phones, monitors, drones, automotive batteries, powertrains for electric vehicles (EVs), power electronics, avionics devices, power devices and displays. In some applications, such as batteries, these working fluids can temporarily act as heating fluids, for instance during cold weather start-up. The invention's technical objective is to provide novel specialty fluids for thermal management, with close to ambient and slightly elevated boiling temperature ranges, where these products are environmentally friendly (low GWP and ODP), non-flammable, non-electrically conductive and have adequate heat transfer properties.

### SUMMARY

The present disclosure provides an azeotropic or azeotrope-like composition comprising perfluoroheptene and an effective amount of a fluorinated ether selected from 1,1,2,2-tetrafluoroethyl-2,2,2-trifluoroethyl ether (HFE-347pcF), nonafluorobutyl methyl ether (HFE-7100) and nonafluorobutyl ethyl ether (HFE-7200). to form an azeotropic composition.

The present disclosure further provides a method for removing residue from a surface of an article comprising: (a) contacting the article with a composition an azeotropic or azeotrope-like composition of perfluoroheptene and a fluorinated ether selected from 1,1,2,2-tetrafluoroethyl-2,2,2-trifluoroethyl ether, nonafluorobutyl methyl ether and nonafluorobutyl ethyl ether; and (b) recovering the surface from the composition.

The present disclosure also provides a method for depositing a fluorolubricant onto a surface of an article comprising: (a) combining a fluorolubricant and a solvent, thereby forming a mixture, wherein the solvent comprises an azeotropic or azeotrope-like composition of perfluoroheptene and a fluorinated ether selected from 1,1,2,2-tetrafluoroethyl-2,2,2-trifluoroethyl ether, nonafluorobutyl methyl ether and nonafluorobutyl ethyl ether; (b) contacting the mixture with the surface of the article; and (c) evaporating the solvent from the surface of the article to form a fluorolubricant coating on the surface.

The present disclosure also provides an immersion cooling unit including an immersion cell, defining an internal cavity, is provided. An electronic or electrical component is positioned in the internal cavity. A dielectric working fluid partially fills the internal cavity and at least partially immerses the energy storage device, IT equipment, computer server etc. The dielectric working fluid includes at least one of the azeotropic or azeotrope-like compositions comprising perfluoroheptene and an effective amount of a fluorinated ether selected from 1,1,2,2-tetrafluoroethyl-2,2,2-trifluoroethyl ether (HFE-347pcF), nonafluorobutyl methyl ether (HFE-7100) and nonafluorobutyl ethyl ether (HFE-7200).

The present disclosure also provides a method for cooling electrically charged equipment, such as but not limited to energy storage devices (such as batteries), IT equipment, computer servers including those used in data centers and crypto currency mining applications, is provided. The method includes at least partially immersing an electrical component in a working fluid; and transferring heat from the electrical component using the working fluid; wherein the working fluid comprises at least one of the azeotropic or azeotrope-like compositions comprising perfluoroheptene and an effective amount of a fluorinated ether selected from 1,1,2,2-tetrafluoroethyl-2,2,2-trifluoroethyl ether (HFE-347pcF), nonafluorobutyl methyl ether (HFE-7100) and nonafluorobutyl ethyl ether (HFE-7200).

### BRIEF DESCRIPTION OF THE DRAWINGS

Embodiments are illustrated in the accompanying figures to improve understanding of concepts as presented herein.

FIG. 1 shows a vapor-liquid equilibrium curve for mixtures of perfluoroheptene and HFE-347pcF.

FIG. 2 shows a vapor-liquid equilibrium curve for mixtures of perfluoroheptene and HFE-7100.

FIG. 3 shows a vapor-liquid equilibrium curve for mixtures of perfluoroheptene and HFE-7200.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present disclosure, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

Many aspects and embodiments have been described above and are merely exemplary and not limiting. After reading this specification, skilled artisans appreciate that other aspects and embodiments are possible without departing from the scope of the invention.

Described herein are azeotropic and azeotrope-like compositions of perfluoroheptene and a fluorinated ether as described below. Also described herein are novel methods of using an azeotropic or azeotrope-like composition comprising perfluoroheptene and a fluorinated ether.

In some embodiments, the perfluoroheptene comprises a mixture of perfluorohept-3-ene (PFO-161-14mcyy) and perfluorohept-2-ene (PFO-161-14myy). In some embodiments, the perfluoroheptene comprises about 85 to about 95 weight percent perfluorohept-3-ene and about 5 to about 15 weight percent perfluorohept-2-ene. In some embodiments, the perfluoroheptene comprises about 90 weight percent perfluorohept-3-ene and about 10 weight percent perfluorohept-2-ene. Nonafluorobutyl methyl ether comprises a mixture of nonafluoro-n-butyl methyl ether and nonafluoro-sec-butyl ethyl ether. Nonafluorobutyl ethyl ether comprises a mixture of nonafluoro-n-butyl ethyl ether and nonafluoro-sec-butyl ethyl ether. Nonafluorobutyl methyl ether and Nonafluorobutyl ethyl ether are available from 3M Corporation as Novec 7100 and Novec 7200 respectively.

As used herein, an azeotropic composition is a constant boiling liquid admixture of two or more substances wherein the admixture distills without substantial composition change and behaves as a constant boiling composition. Constant boiling compositions, which are characterized as azeotropic, exhibit either a maximum or a minimum boiling point, as compared with that of the non-azeotropic mixtures of the same substances. In one embodiment, an azeotropic composition is a specific composition of two or more substances which exhibits a constant minimum or maximum temperature. In another embodiment, an azeotropic composition is a mixture of two or more substances which exhibits a constant minimum or maximum temperature over a range of compositions. Azeotropic compositions include homogeneous azeotropes which are liquid admixtures of two or more substances that behave as a single substance, in that the vapor, produced by partial evaporation or distillation of the liquid, has the same composition as the liquid. Azeotropic compositions, as used herein, also include heterogeneous azeotropes where the liquid phase splits into two or more liquid phases. In these embodiments, at the azeotropic point, the vapor phase is in equilibrium with two liquid phases and all three phases have different compositions. If the two equilibrium liquid phases of a heterogeneous azeotrope are combined and the composition of the overall liquid phase calculated, this would be identical to the composition of the vapor phase.

As used herein, the term “azeotrope-like composition” also sometimes referred to as “near azeotropic composition,” means a constant boiling, or substantially constant boiling liquid admixture of two or more substances that behaves as a single substance. One way to characterize an azeotrope-like composition is that the vapor produced by partial evaporation or distillation of the liquid has substantially the same composition as the liquid from which it was evaporated or distilled. That is, the admixture distills or refluxes without substantial composition change. Alternatively, an azeotrope-like composition may be characterized as a composition having a boiling point temperature of less than the boiling point of each pure component.

Further, yet another way to characterize an azeotrope-like composition is that the bubble point pressure of the composition and the dew point vapor pressure of the composition at a particular temperature are substantially the same. Azeotrope-like compositions exhibit dew point pressure and bubble point pressure with virtually no pressure differential. Hence, the difference in the dew point pressure and bubble point pressure at a given temperature will be a small value. It may be stated that compositions with a difference in dew point pressure and bubble point pressure of less than or equal to 3 percent (based upon the bubble point pressure) may be considered to be azeotrope-like.

In another embodiment, azeotrope-like compositions exhibit a boiling vapor at a temperature within 0.1° C. of the minimum or maximum boiling temperature of the azeotropic composition. In another embodiment, azeotrope-like compositions exhibit a boiling vapor at a temperature within 0.5° C. of the minimum or maximum boiling temperature of the azeotropic composition. In yet another embodiment, azeotrope-like compositions exhibit a boiling vapor at a temperature within 1.0° C. of the minimum or maximum boiling temperature of the azeotropic composition.

A composition of one embodiment of the invention comprises perfluoroheptene and an effective amount of a fluorinated ether selected from 1,1,2,2-tetrafluoroethyl-2,2,2-trifluoroethyl ether (HFE-347pcF), nonafluorobutyl methyl ether (HFE-7100) and nonafluorobutyl ethyl ether (HFE-7200). to form an azeotropic composition. An “effective amount” is defined as an amount which, when combined with perfluoroheptene, results in the formation of an azeotropic or near-azeotropic mixture.

Compositions may be formed that comprise azeotropic or azeotrope-like combinations of perfluoroheptene and a fluorinated ether selected from 1,1,2,2-tetrafluoroethyl-2,2,2-trifluoroethyl ether (HFE-347pcF), nonafluorobutyl methyl ether (HFE-7100) and nonafluorobutyl ethyl ether (HFE-7200). In one embodiment these include compositions comprising perfluoroheptene and 1,1,2,2-tetrafluoroethyl-2,2,2-trifluoroethyl ether. In another embodiment, these include compositions comprising perfluoroheptene and nonafluorobutyl methyl ether. In yet another embodiment, these include compositions comprising perfluoroheptene and nonafluorobutyl ethyl ether.

In one embodiment, the azeotropic compositions comprise from 31.7 to 47.8 wt percent perfluoroheptene and from 52.2 to 68.3 wt percent of HFE-347pcF. In another embodiment, the azeotropic compositions comprise from 0.9 to 10.1 wt percent perfluoroheptene and from 89.9 to 99.1 wt percent HFE-7100. In yet another embodiment, the azeotropic compositions comprise from 79.5 to 84.8 wt percent perfluoroheptene and from 15.2 to 20.5 wt percent HFE-7200.

In one embodiment, the azeotropic compositions consist essentially of from 31.7 to 47.8 wt percent perfluoroheptene and from 52.2 to 68.3 wt percent of HFE-347pcF. In another embodiment, the azeotropic compositions consist essentially of from 0.9 to 10.1 wt percent perfluoroheptene and from 89.9 to 99.1 wt percent HFE-7100. In yet another embodiment, the azeotropic compositions consist essentially of from 79.5 to 84.8 wt percent perfluoroheptene and from 15.2 to 20.5 wt percent HFE-7200.

In one embodiment, the azeotropic compositions consist of from 31.7 to 47.8 wt percent perfluoroheptene and from 52.2 to 68.3 wt percent of HFE-347pcF. In another embodiment, the azeotropic compositions consist of from 0.9 to 10.1 wt percent perfluoroheptene and from 89.9 to 99.1 wt percent HFE-7100. In yet another embodiment, the azeotropic compositions consist of from 79.5 to 84.8 wt percent perfluoroheptene and from 15.2 to 20.5 wt percent HFE-7200.

In another embodiment, the azeotrope-like compositions comprise from 24 to 52 wt percent perfluoroheptene and from 48 to 76 wt percent of HFE-347pcF. In another embodiment, the azeotropic compositions comprise from 0.9 to 14 wt percent perfluoroheptene and from 86 to 99.1 wt percent HFE-7100. In yet another embodiment, the azeotropic compositions comprise from 74.3 to 89.5 wt percent perfluoroheptene and from 10.5 to 25.7 wt percent HFE-7200.

In another embodiment, the azeotrope-like compositions consist essentially of from 24 to 52 wt percent perfluoroheptene and from 48 to 76 wt percent of HFE-347pcF. In another embodiment, the azeotropic compositions consist essentially of from 0.9 to 14 wt percent perfluoroheptene and from 86 to 99.1 wt percent HFE-7100. In yet another embodiment, the azeotropic compositions consist essentially of from 74.3 to 89.5 wt percent perfluoroheptene and from 10.5 to 25.7 wt percent HFE-7200.

In another embodiment, the azeotrope-like compositions consist of from 24 to 52 wt percent perfluoroheptene and from 48 to 76 wt percent of HFE-347pcF. In another embodiment, the azeotropic compositions consist of from 0.9 to 14 wt percent perfluoroheptene and from 86 to 99.1 wt percent HFE-7100. In yet another embodiment, the azeotropic compositions consist of from 74.3 to 89.5 wt percent perfluoroheptene and from 10.5 to 25.7 wt percent HFE-7200.

In another embodiment, the azeotrope-like compositions comprise from 16.8 to 56 wt percent perfluoroheptene and from 44 to 83.2 wt percent of HFE-347pcF. In another embodiment, the azeotropic compositions comprise from 0.9 to 27.3 wt percent perfluoroheptene and from 72.7 to 99.1 wt percent HFE-7100. In yet another embodiment, the azeotropic compositions comprise from 67.8 to 93.4 wt percent perfluoroheptene and from 6.6 to 32.2 wt percent HFE-7200.

In another embodiment, the azeotrope-like compositions consist essentially of from 16.8 to 56 wt percent perfluoroheptene and from 44 to 83.2 wt percent of HFE-347pcF. In another embodiment, the azeotropic compositions consist essentially of from 0.9 to 27.3 wt percent perfluoroheptene and from 72.7 to 99.1 wt percent HFE-7100. In yet another embodiment, the azeotropic compositions consist essentially of from 67.8 to 93.4 wt percent perfluoroheptene and from 6.6 to 32.2 wt percent HFE-7200.

In another embodiment, the azeotrope-like compositions consist of from 16.8 to 56 wt percent perfluoroheptene and from 44 to 83.2 wt percent of HFE-347pcF. In another embodiment, the azeotropic compositions consist of from 0.9 to 27.3 wt percent perfluoroheptene and from 72.7 to 99.1 wt percent HFE-7100. In yet another embodiment, the azeotropic compositions consist of from 67.8 to 93.4 wt percent perfluoroheptene and from 6.6 to 32.2 wt percent HFE-7200.

In another embodiment, the azeotrope-like compositions comprise from 6.1 to 61.1 wt percent perfluoroheptene and from 38.9 to 93.9 wt percent of HFE-347pcF. In another embodiment, the azeotropic compositions comprise from 0.9 to 40.3 wt percent perfluoroheptene and from 59.7 to 99.1 wt percent HFE-7100. In yet another embodiment, the azeotropic compositions comprise from 61.3 to 99.7 wt percent perfluoroheptene and from 0.3 to 38.7 wt percent HFE-7200.

In another embodiment, the azeotrope-like compositions consist essentially of from 6.1 to 61.1 wt percent perfluoroheptene and from 38.9 to 93.9 wt percent of HFE-347pcF. In another embodiment, the azeotropic compositions consist essentially of from 0.9 to 40.3 wt percent perfluoroheptene and from 59.7 to 99.1 wt percent HFE-7100. In yet another embodiment, the azeotropic compositions consist essentially of from 61.3 to 99.7 wt percent perfluoroheptene and from 0.3 to 38.7 wt percent HFE-7200.

In another embodiment, the azeotrope-like compositions consist of from 6.1 to 61.1 wt percent perfluoroheptene and from 38.9 to 93.9 wt percent of HFE-347pcF. In another embodiment, the azeotropic compositions consist of from 0.9 to 40.3 wt percent perfluoroheptene and from 59.7 to 99.1 wt percent HFE-7100. In yet another embodiment, the azeotropic compositions consist of from 61.3 to 99.7 wt percent perfluoroheptene and from 0.3 to 38.7 wt percent HFE-7200.

In some embodiments, the compositions of the present application further comprise stabilizers that reduce degradation over time and elevated temperatures.

The present application provides compositions, comprising perfluoroheptene azeotrope compositions and an additional component selected from the group consisting of one or more antioxidants and one or more acid scavengers, or any mixture thereof.

In some embodiments, the one or more acid antioxidants are selected from butylated hydroxy toluene (BHT), hydroquinone monomethyl ether (HQMME), 2-tert-butyl-6-methylphenol, 2-tert-butyl-5-methylphenol and 2-tert-butyl-4-ethylphenol. In some embodiments, the one or more scavengers are selected from 1,3-dioxolane, 1,2-epoxybutane and nitromethane.

Large scale computer server systems can perform significant workloads and generate a large amount of heat during their operation. A significant portion of the heat is generated from their operation. Due in part to the amount of heat generated, these systems are typically mounted in stacked configurations with large internal cooling fans and heat dissipating fins. As the size and density of these systems increases the thermal challenges are even greater, and eventually outpace the ability for forced air systems.

Two-phase immersion cooling is an emerging cooling technology for the high performance cooling market as applied to high performance high power density server systems, IT equipment used in Data centers, crypto currency mining facilities. It relies on the heat absorbed in the process of vaporizing an immersion liquid into a gas. The fluids used in this application must meet certain requirements to be viable in use. For example, the boiling temperature of the fluid should be in the range between 30-75° C. Generally, this range accommodates maintaining the server components at a sufficiently cool temperature while allowing generated heat to be dissipated sufficiently to an external heat sink. Alternatively, the operating temperature of the server, and the immersion cooling system could be raised or lowered, by using an enclosed system and raising or lowering the pressure within the system to raise or lower the boiling point of a given fluid.

Single phase immersion cooling has a long history in computer server cooling. There is no phase change in single phase immersion cooling. Instead, the liquid warms as it circulates through the computer server or heat generating device, and then is circulated with a pump to a heat exchanger for cooling prior to returning to the server or heat generating device, thus transferring heat away from those components. Fluids used for single phase immersion cooling have the same requirements as those for two-phase immersion cooling, except that the boiling temperatures are typically higher than 30-75° C., to reduce loss by evaporation.

Provided is an immersion cooler having an operating temperature range near ambient temperatures. Embodiments of the present disclosure, for example, in comparison to concepts failing to include one or more of the features disclosed herein, provide an immersion cooler having fluids for thermal management which are environmentally friendly (i.e., have a low global warming potential (GWP) and low ozone depletion potential (ODP)).

Also provided is a method of immersion cooling wherein the device is a heat generating component, comprising at least partially immersing the heat generating component into the immersion cooling fluid in a liquid state, and transferring heat from the heat generating component using the immersion cooling fluid. Such devices include high capacity energy storage devices, electrical components, IT equipment, computer servers, mechanical components and optical components. Examples of devices of the present disclosure include, but are not limited to, microprocessors, wafers used to manufacture semiconductor devices, power control semiconductors, electrical distribution switch gear, power transformers, circuit boards, multi-chip modules, packaged and unpackaged semiconductor devices, laser, fuel cells, electrochemical cells and energy storage devices such as batteries. In some embodiments the device can include a chiller, a heater, or a combination thereof.

In certain embodiments, the devices can include electronic devices, such as processors, including microprocessors. Microprocessors typically have maximum operating temperatures of about 85° C., so effective heat transfer is required in conditions of high processing power, i.e. high heat rejection rates. In other embodiments, the devices may include energy storage systems, such as batteries. When rapidly charged or discharged, batteries can reject a significant amount of heat that needs to be effectively removed to avoid overheating, internal damage, thermal runaway to adjacent batteries and potentially fire. As these electronic and electric devices become denser, and more powerful, the amount heat generated per unit of time and volume increases. Therefore, the mechanism of heat transfer plays an important role in processor performance. The heat transfer fluid typically has good heat transfer performance, good electrical compatibility (even if used in “indirect contact” applications such as those employing cold plates), as well as low toxicity, low or nonflammability and low environmental impact. Good electrical compatibility suggests that the heat-transfer fluid candidate exhibit high dielectric strength, high volume resistivity, low dissipation factor, low dielectric constant and poor solvency for polar materials. Additionally, the heat-transfer fluid should exhibit good material compatibility, that is, it should not affect typical materials of construction in an adverse manner.

It is generally understood that perfluorinated liquids such as Fluoroinert FC-72 and FC-3284 may exhibit excellent dielectric properties such as dielectric constants of 2.0 or less, high volume resistivity on the order of 10¹⁵ ohm-cm and high dielectric strength. However, these fluids are also generally associated with a high GWP, well outside the current requirements for many industrial applications. The GWP of Fluorinert FC-72 is reported to be >9000. Hydrofluoroethers (HFEs) have lower GWP's but are still not satisfactory and typically have poorer dielectric properties compared to FC-72 and FC-3284. Novec 7100 for example has a GWP of 297. Therefore, there continues to be a need for working fluids for immersion cooling that satisfy the dielectric applications of the industry while having a GWP at least as low as current HFE's. In another embodiment, the GWP of a working fluid is less than 100. In another embodiment, the compositions disclosed have a Global Warming Potential (GWP) of not greater than 50. As used herein, “GWP” is measured relative to that of carbon dioxide and over a 100-year time horizon, as defined in AR4 of the IPCC (Intergovernmental Panel on Climate Change).

It is highly desirable that the new fluids have equivalent or superior heat transfer properties, including electronic surface-to-fluid thermal resistance, critical heat flux and fluid-to-condenser thermal resistance, compared to higher GWP existing fluids such as FC-72, FC-3284, HFE-7100 and HFE-7200 so that they can replace these fluids in existing systems without significant loss in thermal performance or mechanical modifications, and in new systems designed for FC-72, FC-3284, HFE-7100 and HFE-7200 without significant mechanical design changes. The practice of replacing an existing fluid with a new fluid in an existing system is often called “retrofit”.

It is also desirable that these fluids have similar normal boiling points compared to high GWP fluids such as FC-72, FC-3284, HFE-7100 and HFE-7200 so that they can be used to replace these in existing systems without significant mechanical or operational changes; and in new systems without significant mechanical design changes.

It is also highly desirable that the new fluids provide at least minimum dielectric properties required by the application, or even superior dielectric properties compared to existing fluids such as such as FC-72, FC-3284, HFE-7100 and HFE-7200 so that they can replace these fluids in existing systems without significant electrical or mechanical modifications; and in new systems designed for FC-72, FC-3284, HFE-7100 and HFE-7200 without significant electrical or mechanical design changes. The desirable dielectric properties include high volume resistivity, low dielectric constant, high dielectric strength and low loss tangent.

Suitable compounds and compositions useful alone or in combination as dielectric working fluids are shown in Table 1.

TABLE 1

| | | Normal | | Volume | |
|---|---|---|---|---|---|
| Azeotrope | Compo- | Boiling | Dielectric | Resistivity | |
| blend | sition | Point | Constant | (Ohm-cm) | GWP |
| Perfluoroheptene/ | 48:52 | 57.4 | 3.8 | 7.6E+10 | 303 |
| HFE-347pcF | | | | | |
| Perfluoroheptene/ | 32:68 | 54.2 | 4.7 | 3.0E+10 | 395 |
| HFE-347pcF | | | | | |
| Perfluoroheptene/ | 56:44 | 54.7 | 3.5 | 1.6E+11 | 256 |
| HFE-347pcF | | | | | |
| Perfluoroheptene/ | 17:83 | 54.6 | 5.5 | 3.2E+10 | 482 |
| HFE-347pcF | | | | | |
| Perfluoroheptene/ | 10:90 | 61.4 | 6.2 | 5.6E+10 | 268 |
| Nonafluorobutyl | | | | | |
| methyl ether | | | | | |
| Perfluoroheptene/ | 27:73 | 61.7 | 5.4 | 8.4E+10 | 217 |
| Nonafluorobutyl | | | | | |
| methyl ether | | | | | |
| Perfluoroheptene/ | 82:18 | 69.1 | 2.8 | 1.1E+13 | 12 |
| Nonafluorobutyl | | | | | |
| ethyl ether | | | | | |
| Perfluoroheptene/ | 68:32 | 69.4 | 3.6 | 5.7E+11 | 20 |
| Nonafluorobutyl | | | | | |
| ethyl ether | | | | | |
| HFE-7100 | | 61 | 7.4 | 1E+8 | 597 |
| HFE-7200 | | 76 | 7.3 | 1E+8 | 59 |
| FC-72 | | 56 | 1.75 | 1E+15 | ~9500 |
| FC-3284 | | 50 | 1.86 | 7E+15 | ~9500 |
| HT-55 | | 55 | 1.86 | 1E+12 | ~10,000 |

In one embodiment the working fluid may be selected from the group of the azeotrope and azeotrope-like compositions listed in Table 1.

It can be seen that the Perfluoroheptene-based blends proposed have superior dielectric properties compared to HFE-7100 and HFE-7200, in terms of lower dielectric constant and higher volume resistivity. Perfluoroheptene-based also have significantly lower GWP, at least about 95% lower than FC-72 and FC-3284.

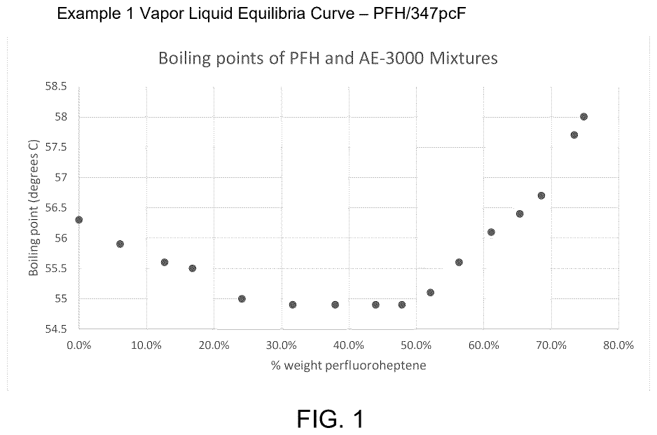

An embodiment of an immersion cooling unit 100 is shown in FIG. 1. The immersion cooling system 100 includes an immersion cell 110 defining an internal cavity 120. A heat generating electrically charged component, (such as an energy storage device) 130, to be cooled, may be placed in the internal cavity 120. A dielectric working fluid 140 partially fills the internal cavity 120. The dielectric working fluid 140 at least partially immerses the energy storage device 130. In some embodiments, the dielectric working fluid 140 substantially immerses the energy storage device 130. In one embodiment, the dielectric working fluid 140 completely immerses the energy storage device 130. A condensing coil 150 is additionally present in the internal cavity 120. The condensing coil 150 may be spatially located above at least a portion of the dielectric working fluid 140.

During operation, heat generated by the electrical component 130, heats the dielectric working fluid 140 causing a portion of the dielectric working fluid 140 to vaporize. The dielectric working fluid 140 vapors contact the condensing coil 150 above the dielectric working fluid 140 and transfer thermal energy to the condensing coil 150 allowing the condensate dielectric working fluid 140 to precipitate back into the liquid dielectric working fluid 140 below. The thermal energy transferred to the condensing coil 150 is transported external to the immersion cell 110 and released into the environment or to a chiller via a heat exchanger 160. The thermal energy released can also be recovered and used for heating applications or for energy generation such as Rankine cycles.

The dielectric working fluids of the immersion cooler 100 are selected to undergo a phase transition from the liquid to the gaseous state over the operational temperature range of the immersion cooler 100. In some embodiments, the composition of the dielectric working fluids 140 includes one or more fluorinated compounds. In some embodiments, the dielectric working fluids 140 include one or more compounds including fluorine. In some embodiments, the operational temperature is at least 25° C., at least 30° C., at least 40° C., at least 50° C., at least 60° C., less than 100° C., less than 90° C., less than 80° C., less than 70° C., less than 60° C., and combinations thereof.

In one embodiment the normal boiling point of the new low-GWP dielectric fluid may be within at least 10° C. of the fluid being replaced. In another embodiment the normal boiling point of the new low-GWP dielectric fluid may be within 8° C. In yet another embodiment, the normal boiling point of the new low-GWP dielectric fluid may be within 5° C.

The dielectric working fluids 140 may also be selected to exhibit a dielectric constant, volume resistivity, dielectric strength and loss tangent (dissipation factor) suitable for direct contact with electrical components. In general, materials exhibiting a low dielectric constant, low loss tangent or dissipation factor, high volume resistivity and large dielectric strength provide increased electrical insulation of the energy storage device, or electrically charged components, 130, immersed therein as well as reduced signal loss. In some embodiments, the dielectric constant of the dielectric working fluids 140 is less than about 8 over the operational frequency range (which can go as high as 100 GHz), preferable lower than HFE-7100 and HFE-7200. Suitable dielectric working fluids include compounds and mixtures having a dielectric constant over the operational frequency range (up to about 100 GHz) of less than 7.3, or less than 5.5, or less than 5.0, or less than 4.0, or less than 3.5, or less than 2.7. Other embodiments include compounds and mixtures having a dielectric constant greater than 1.0 and less than 8.0 or greater than 2.0 and less than 7.3 or greater than 2.5 and less than 5.5 or greater than 3.5 and less than 5.0.

In one embodiment, the dielectric constant of the new low GWP fluid is at least about 15% lower than HFE-7100 or HFE-7200. In another embodiment, the dielectric constant of the new low GWP fluid is at least about 25% lower than HFE-7100 or HFE-7200. In another embodiment, the dielectric constant of the new low GWP fluid is at least about 35% lower than HFE-7100 or HFE-7200. In another embodiment, the dielectric constant of the new low GWP fluid is at least about 50% lower than HFE-7100 or HFE-7200, even at high frequencies up to about 60 GHz or as high as 100 GHz.

Another characteristic of a good working fluid is that it possesses a high volume resistivity. Volume resistivity is an intrinsic property which measures how strongly a material resists electric current per unit length of a unit cross section, typically expressed in units of ohm-cm or ohm-m. A higher volume resistivity means the material is a better electrical insulator. The electrical resistance of material can be calculated by multiplying volume resistivity by the length and dividing by the cross-sectional area of the material.

So, a higher volume resistivity dielectric fluid is desirable as it leads to a higher electrical resistance and, consequently, a lower current leakage. Current leakage, for instance, can lead to self-discharge of energy storage devices such as batteries. It also means electrical components with different voltage can be placed closer (smaller “L”) for a given minimum resistance requirement, potentially leading to more compact assemblies. In one embodiment effective working fluids have a volume resistivity, measured at 25° C. of at least 1×10¹⁰ ohm-cm. In another embodiment, an effective working fluid has a volume resistivity of at least 1×10¹¹ ohm-cm. In another embodiment, an effective working fluid has a volume resistivity of at least 1×10¹² ohm-cm. Water is known for having much lower volume resistivity. Thus, fluids with high volume resistivity are also desirable as, in case of the presence of water in the fluid, they would still maintain adequate levels of actual volume resistivity.

In one embodiment the volume resistivity of the new low-GWP fluid must be higher than about 1.0×10¹¹. In another embodiment, the volume resistivity is at least about one order of magnitude higher than HFE-7100 and 7200. In another embodiment the volume resistivity is at least about two orders of magnitude higher than HFE-7100 and 7200. In another embodiment the volume resistivity is at least about three orders of magnitude higher than HFE-7100 and 7200. In another embodiment the volume resistivity is at least about four orders of magnitude higher than HFE-7100 and 7200.

Another important dielectric fluid property is the dielectric strength which is defined as the maximum electric field or voltage, per unit of length, a material can resist without undergoing electrical breakdown and becoming electrically conductive. It is typically measured in units of kV/mm or kV/0.1″ gap. For a given distance or “gap”, the voltage at which a material becomes electrically conductive is called the breakdown voltage. A higher dielectric strength material is advantageous since it allows a higher voltage between two conductors or it allows two conductors to be placed closer, leading to potentially more compact assemblies. In one embodiment, the dielectric strength is greater than about 10 kV/0.1″ gap. In another embodiment, the dielectric strength is greater than about 20 kV/0.1″ gap. In yet another embodiment, the dielectric strength is greater than about 30 kV/0.1″ gap. In yet another embodiment, the dielectric strength is greater than about 35 kV/0.1″ gap.

Dielectric loss tangent, sometimes called a dissipation factor, is another critical dielectric property particularly in high frequencies due to its impact on signal attenuation or signal loss. It is defined with the tan(S), which is the ration of the imaginary component to the relative real component of the permittivity. It is also a measure of the rate at which energy carried by the electromagnetic field (RF) traveling through a dielectric is absorbed by that dielectric, i.e. it quantifies the dissipation of electromagnetic energy in the form of heat. Furthermore, the loss tangent is highly dependent on frequency and can increase particularly above frequencies of 1 GHz which can be found in applications such as data center, 5G and Wi-fi technology. More importantly, the signal loss or attenuation per unit length, typically measured in terms of dB/cm is proportional to the loss tangent. In other words, for a signal travelling through a dielectric fluid, the higher the loss tangent of the fluid, the higher the signal loss per unit length and consequently the shorter the distance it can travel. Thus, it is very desirable that dielectric fluids have low loss tangent values in frequencies above 1 GHz to up to about 100 GHz. The fluids discovered by the inventors have shown very favorable values of loss tangent at high frequencies.

The inventors have also discovered that the new proposed low-GWP fluids have equivalent and sometimes lower values of loss tangent compared to fluids such as HFE-7100 and HFE-7200, particularly in high frequency.

All desirable dielectric properties aforementioned, high dielectric strength, low dielectric constant, low loss tangent and high volume resistivity must be present primarily in the liquid phase but also in the vapor phase.

Other desirable characteristic of an immersion cooling fluid relates its ability of not significantly damaging, or not significantly reacting with, IT and computer parts such as cables, wires, seals, metals, among other parts, as well as constructions materials of the tank which are exposed to the dielectric fluid.

It is also desirable that these fluids have similar interactions with electronic components compared to the existing fluids so to minimize the replacement of parts.

Contaminant control measures, such as filter system, may be used to remove solid or liquid residues that may be generated as a result of reactivity with materials of construction. Contamination control measures can also be used to maintain low enough acid and water levels.

Typical non-condensable gases, such nitrogen and oxygen, can also be present in the dielectric fluid and can be detrimental to boiling and condensation heat transfer. Thus, systems with dielectric two-phase fluids may be equipped with a supplemental device that at least partially removes or controls the level of non-condensable levels in the dielectric fluid.

The ability of the working fluid 140 to transport heat is related to the heat of vaporization of the dielectric working fluid 140. Typically, the greater the heat of vaporization of the dielectric working fluids 140, the greater amount of energy that the working fluid 140 will absorb during vaporization and transport to the condensing coil 150 to be released during condensation.

It is also desirable that these fluids are non-flammable or present no flash point. Standards such as ASTM D56, D1310, and E681 can be used to assess flammability.

Since the objective of these fluids is to remove heat from energy storage devices, one important consideration is how good of a two-phase heat transfer the dielectric fluid is. More specifically, how good of a heat transfer these fluids are under pool boiling conditions. Pool boiling heat transfer is typically divided into different modes or regimes:
1) Free convection: happens at small values of “wall superheat” or “excess temperature”—the difference between saturation temperature of the fluid and the wall or surface temperature
2) Nucleate boiling: occurs when there is high enough superheat for bubbles to form and separate from the surface, significantly improving heat transfer coefficient and heat flux. This mode is typically the preferred regime of boiling operation for heat removal. The nucleation boiling region is limited by the Critical Heat Flux (CHF) with units of kW/m². Heat transfer devices are usually designed to operate at heat fluxes lower than the CHF. The critical heat flux is particular to each fluid and depends on several thermophysical properties. It can be experimentally measured or estimated through semi-empirical models such as the one by Zuber (1958). Fluids with higher CHFs are desirable because they can remove more heat per unit of area, for a given wall superheat.
3) Transition boiling: a vapor film begins to form in the surface and there is an oscillation between nucleate and film boiling. The regime is unstable and not desirable to operate.
4) Film boiling: In this region the wall superheat is so high that a vapor blanket forms between the liquid and the surface—significantly reducing heat transfer coefficients. This region is also not desirable to operate.

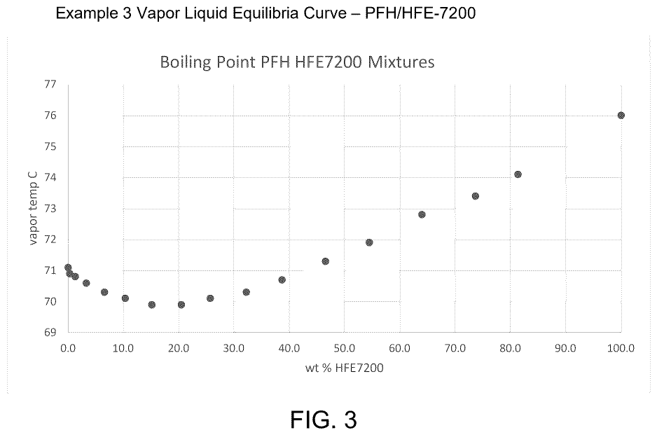

These regimes are illustrated in FIG. 3.

TABLE 2
Critical Heat Flux of Working Fluids calculated
at sea level atmospheric pressures (101.325 kPa)

| | Critical Heat |
|---|---|
| Working Fluid | Flux (kW/m²) |
| Perfluoroheptene/HFE-347pcF | 191 |
| 48:52 | |
| Perfluoroheptene/HFE-347pcF | 204 |
| 32:68 | |
| Perfluoroheptene/HFE-347pcF | 184 |
| 56:44 | |
| Perfluoroheptene/HFE-347pcF | 216 |
| 17:83 | |
| Perfluoroheptene/Nonafluorobutyl | 190 |
| methyl ether 10:90 | |
| Perfluoroheptene/Nonafluorobutyl | 184 |
| methyl ether 27:73 | |
| Perfluoroheptene/Nonafluorobutyl | 161 |
| ethyl ether 82:18 | |
| Perfluoroheptene/Nonafluorobutyl | 164 |
| ethyl ether 68:32 | |
| 3M Novec ™ 7100 | 193 |
| 3M Novec ™ 7200 | 179 |
| FC-72 | 154 |

Table 2 shows that the HFO mixtures proposed have comparable and sometimes higher CHFs than legacy fluids. Particularly, all proposed mixtures have superior CHF compared to legacy fluid with high GWP FC-72. Mixtures of Perfluoroheptene with HFE-7100 have a CHF within only 10% of pure HFE-7100 while mixtures of Perfluoroheptene with HFE-7200 are also within about 10% of HFE-7200 alone. The CHFs were obtained using Zuber (1958) correlation at sea level atmospheric pressure (101.325 kPa) while thermophysical properties were determined through REFPROP 10. REFPROP 10 thermophysical properties were obtained using experimental data. Another aspect of boiling heat transfer is the heat transfer coefficient in the nucleate boiling region. It is measured in terms of heat removed (in units of “Watts” for instance), per unit of area (in units of “cm²” for instance), per unit of temperature difference between the surface and the bulk fluid (in units of “Kelvin” for instance).

In one embodiment, it is highly desirable that the new low GWP fluids provide an equivalent or higher critical heat flux than the higher or equivalent GWP fluids they are replacing. In another embodiment, the new low GWP fluids should provide a critical heat flux of no less than 90%. In yet another embodiment, the new low GWP fluid should provide a critical heat flux of no less than 80% of that of high or equivalent GWP fluids so that there are no significant changes to the maximum heat flux dissipation in an existing immersion cooling system or major design changes to immersion cooling systems designed for higher GWP fluids.

A higher boiling heat transfer coefficient is desirable as it leads to a lower overall thermal resistance, or a lower temperature of the electrical component being cooled. The boiling heat transfer coefficient and the electrical component-to-fluid thermal resistance can be improved with the use of surface enhancements which increase the number of nucleation sites.

The electrical component-to-fluid thermal resistance can be determined by the inverse of the product between boiling heat transfer coefficient and the heat transfer area of the electronic/electrical component.

In one embodiment, the electrical component-to-fluid thermal resistance of the new fluids must be lower or equivalent compared to the existing high GWP fluid. In another embodiment, the electrical component-to-fluid thermal resistance of the new fluids must be no more than 10% higher than that of the existing high or equivalent GWP fluid than that of the existing high GWP fluid. In yet another embodiment, the electrical component-to-fluid thermal resistance of the new fluids must be no more than 20% higher than that of the existing high or equivalent GWP fluid, so there is no significant increase in temperature of an existing electronic device or no significant mechanical changes have to be implemented in a system design for a high GWP fluid.

Another important aspect of fluids used in two-phase immersion cooling systems is its condensation heat transfer coefficient. Higher condensation heat transfer are desirable as they lead to reduced vapor-to-condenser surface thermal resistance or lower temperature difference between the condensing vapor and the coolant that removes the heat. Condensation heat transfer can also be improved with surface enhancements.

The vapor-to-condenser surface thermal resistance can be determined by the inverse of the product between condensation heat transfer coefficient and the heat transfer area of the condenser.

In one embodiment, the vapor-to-condenser thermal resistance of the new fluids must be lower or equivalent compared to the existing high GWP fluid. In another embodiment, the vapor-to-condenser thermal resistance of the new fluids must be no more than 10% higher compared to the existing high or equivalent GWP fluid. In yet another embodiment, the vapor-to-condenser thermal resistance of the new fluids must be no more than 20% higher compared to the existing high or equivalent GWP fluid, so there is no significant drop in condenser performance or no significant mechanical changes, for instance an increase in heat transfer area, have to be implemented in the condenser designed for a high or equivalent GWP fluid.

Combined higher boiling and condensation heat transfer coefficients are highly desirable as they reduce the overall thermal resistance between the coolant and the electronic or electrical equipment and reduce the temperature difference between the two. Better heat transfer coefficients yield better heat removal which, for instance, can allow batteries immersed in a dielectric liquid to be charged at a faster rate without leading to potential thermal runaway.

Heat transfer coefficients can be experimentally measured or calculated using experimentally determined heat transfer correlations combined with experimentally determined thermophysical properties.

TABLE 3
Heat transfer coefficients and temperature difference
at sea level atmospheric pressure

| | Electronic | Vapor to |
|---|---|---|
| | Surface to | Condenser |
| | Fluid Thermal | Surface Thermal |
| | Resistance | Resistance |
| | K/W | K/kW |
| Perfluoroheptene/HFE-347pcF | 0.55 | 2.9 |
| 48:52 | | |
| Perfluoroheptene/HFE-347pcF | 0.55 | 2.8 |
| 32:68 | | |
| Perfluoroheptene/HFE-347pcF | 0.56 | 2.9 |
| 56:44 | | |
| Perfluoroheptene/HFE-347pcF | 0.53 | 2.7 |
| 17:83 | | |
| Perfluoroheptene/Nonafluorobutyl | 0.55 | 3.2 |
| methyl ether 10:90 | | |
| Perfluoroheptene/Nonafluorobutyl | 0.55 | 3.2 |
| methyl ether 27:73 | | |
| Perfluoroheptene/Nonafluorobutyl | 0.59 | 3.3 |
| ethyl ether 82:18 | | |
| Perfluoroheptene/Nonafluorobutyl | 0.58 | 3.3 |
| ethyl ether 68:32 | | |
| Novec 7100 | 0.56 | 3.2 |
| Novec 7200 | 0.55 | 3.4 |
| FC-72 | 0.59 | 3.6 |

In Table 3, the Electronic Surface-to-Fluid Thermal Resistance was determined by the inverse of the product between the pool boiling heat transfer coefficient and an electronic surface heat transfer area of 4 cm². The pool boiling heat transfer coefficient was obtained using Cooper (1984) correlation for nucleate boiling at sea level atmospheric pressures, with roughness of 1 micro-meter and a heat flux of 100 kW/m². The vapor-to-condenser surface thermal resistance was determined by the inverse of the product of the condensation heat transfer coefficient and a condenser surface area of 0.2 m². The condensation heat transfer coefficient was obtained using Dhir and Lienhard (1971) correlation for external condensation on tube bundles at sea level atmospheric pressures and a temperature difference between the bulk fluid and the condenser surface of 8 K.

Table 2 shows that the dielectric fluids claimed have equivalent thermal resistance, within about 10%, compared to legacy fluids such as HFE-7100, HFE-7200 or FC-.

The power usage or efficiency of data centers can be quantified in terms of PUE—Power Utilization Effectiveness. The lower the PUE or the closer to 1.0, the lower the energy utilized to remove a given amount of heat from data centers. It is highly desirable that immersion tanks with dielectric fluids lead to operate at PUE values close to 1.0. The PUE of an immersion cooling tank can be obtained by measuring the overall energy dissipated by the immersed electronic equipment and the energy consumed by the tank. Due to equivalent dielectric, thermodynamic and heat transfer properties, the fluids proposed can also be used to replace the legacy high-GWP fluids such as FC-72, HFE-7100, HFE-7200 or equivalent GWP fluids in existing equipment in a practice often called “retrofit”. The retrofit could be partial when only a percentage of the existing fluid is replaced or full, when the entire fluid is replaced with a new low GWP fluid.

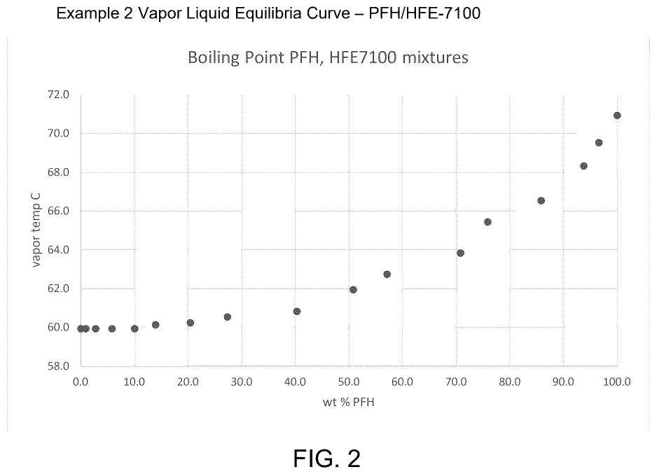

An embodiment of an immersion cooling unit 200 is shown in FIG. 2. The immersion cooling system 200 includes an immersion cell 210 defining an internal cavity 220. An energy storage device 230, to be cooled, may be placed in the internal cavity 220. A dielectric working fluid 240 partially fills the internal cavity 220. The dielectric working fluid 240 at least partially immerses the energy storage device 230. In some embodiments, the dielectric working fluid 240 substantially immerses the energy storage device 230. In one embodiment, the dielectric working fluid 240 completely immerses the energy storage device 230. A cooling unit 250 is positioned externally to the immersion cell 210. The cooling unit 250 is fluidly connected to the immersion cell 210. The cooling unit 250 is configured to fluidly receive at least a portion of the dielectric working fluid 240 from the immersion cell 210. The cooling unit 250 is further configured to extract heat from the dielectric working fluid 240, thereby reducing the temperature of the dielectric working fluid 240. In one embodiment, the cooling unit 250 includes a heat exchanger. In one embodiment, the heat transferred to the cooling unit 250 is released into the environment. The cooling unit 250 is further configured to return the cooled dielectric working fluid 240 to the immersion cooling cell 210. In some embodiments, a motive force may be provided to the dielectric working fluid 240. In one embodiment, the motive force may be provided by one or more circulation pumps 260. In one embodiment, the motive force may be provided by convective flow.

The dielectric working fluids of the immersion cooler 200 are selected to be in the liquid state over the operational temperature range of the immersion cooler 200. In some embodiments, the composition of the dielectric working fluids 240 includes one or more fluorinated compounds. In some embodiments, the dielectric working fluids 240 include one or more compounds including fluorine. In some embodiments, the operational temperature is at least 25° C., at least 30° C., at least 40° C., at least 50° C., at least 60° C., less than 100° C., less than 90° C., less than 80° C., less than 70° C., and combinations thereof.

Due to equivalent or better dielectric, thermodynamic and heat transfer properties, the fluids proposed can also be used to replace the legacy fluids such as HFE-7100, HFE-7200 or other high GWP fluids in existing equipment in a practice often called “retrofit”.

From a practical perspective, liquid water is pushed up into the headspace of the device during startup and operation of the system. The presence of water in the cooling system (particularly in the headspace is undesirable. It may contribute to corrosion of metal components in the headspace of the system. It may contribute to corrosion of metal components in the headspace of the system. The presence of water in the dielectric fluid can be detrimental to its dielectric properties since water has significantly lower resistivity (5×10⁵ ohm-cm for distilled water).

Another embodiment of the disclosure relates to a method of cleaning a surface comprising:
a. contacting the surface with a composition comprising a solvent, wherein the solvent comprises an azeotropic or azeotrope-like composition of perfluoroheptene and a fluorinated ether selected from 1,1,2,2-tetrafluoroethyl-2,2,2-trifluoroethyl ether, nonafluorobutyl methyl ether and nonafluorobutyl ethyl ether, and
b. recovering the surface from the composition.

In one embodiment, the compositions of the invention are useful as cleaning compositions, cleaning agents, deposition solvents and as dewatering or drying solvents. In another embodiment, the invention relates to a process for removing residue from a surface or substrate comprising contacting the surface or substrate with a cleaning composition or cleaning agent of the present disclosure and, optionally, recovering the surface or substrate substantially free of residue from the cleaning composition or cleaning agent.

In yet another embodiment, the present disclosure relates to a method for cleaning surfaces by removing contaminants from the surface. The method for removing contaminants from a surface comprises contacting the surface having contaminants with a cleaning composition of the present invention to solubilize the contaminants and, optionally, recovering the surface from the cleaning composition. The surface is then substantially free of contaminants. As stated previously, the contaminants or residues that may be removed by the present method include, but are not limited to oils and greases, flux residues, and particulate contaminants.

In one embodiment of the present disclosure, the method of contacting may be accomplished by spraying, flushing, wiping with a substrate e.g., wiping cloth or paper, that has the cleaning composition incorporated in or on it. In another embodiment of the present disclosure, the method of contacting may be accomplished by dipping or immersing the article in a bath of the cleaning composition.

In one embodiment of the present disclosure, the process of recovering is accomplished by removing the surface that has been contacted from the cleaning composition bath (in a similar manner as described for the method for depositing a fluorolubricant on a surface as described below). In another embodiment of the invention, the process of recovering is accomplished by allowing the cleaning composition that has been sprayed, flushed, or wiped on the disk to drain away. Additionally, any residual cleaning composition that may be left behind after the completion of the previous steps may be evaporated in a manner similar to that for the deposition method.

In one embodiment, the present cleaning compositions may further comprise a propellant. Aerosol propellant may assist in delivering the present composition from a storage container to a surface in the form of an aerosol. Aerosol propellant is optionally included in the present composition in up to about 25 weight percent of the total composition. Representative aerosol propellants comprise air, nitrogen, carbon dioxide, 2,3,3,3-tetrafluoropropene (HFO-1234yf), trans-1,3,3,3-tetrafluoropropene (HFO-1234ze), 1,2,3,3,3-pentafluoropropene (HFO-1225ye), difluoromethane (CF₂H₂, HFC-32), trifluoromethane (CF₃H, HFC-23), difluoroethane (CHF₂CH₃, HFC-152a), trifluoroethane (CH₃CF₃, HFC-143a; or CHF₂CH₂F, HFC-143), tetrafluoroethane (CF₃CH₂F, HFC-134a; or CF₂HCF₂H, HFC-134), pentafluoroethane (CF₃CF₂H, HFC-125), and hydrocarbons, such as propane, butanes, or pentanes, dimethyl ether, or combinations thereof.

In another embodiment, the present compositions may further comprise at least one surfactant. The surfactants of the present disclosure include all surfactants known in the art for dewatering or drying of substrates. Representative surfactants include alkyl phosphate amine salts (such as a 1:1 salt of 2-ethylhexyl amine and isooctyl phosphate); ethoxylated alcohols, mercaptans or alkylphenols; quaternary ammonium salts of alkyl phosphates (with fluoroalkyl groups on either the ammonium or phosphate groups); and mono- or di-alkyl phosphates of fluorinated amines. Additional fluorinated surfactant compounds are described in U.S. Pat. No. 5,908,822, incorporated herein by reference.

The amount of surfactant included in the dewatering compositions of the present invention can vary widely depending on the particular drying application in which the composition will be used, but is readily apparent to those skilled in the art. In one embodiment, the amount of surfactant dissolved in the unsaturated fluorinated ether solvent is not greater than about 1 weight percent, based on the total weight of the surfactant/solvent composition. In another embodiment, larger amounts of surfactant can be used, if after treatment with the composition, the substrate being dried is thereafter treated with solvent containing either no or minimal surfactant. In one embodiment, the amount of surfactant is at least about 50 parts per million (ppm, on a weight basis). In another embodiment, the amount of surfactant is from about 100 to about 5000 ppm. In yet another embodiment, the amount of surfactant used is from about 200 to about 2000 ppm based on the total weight of the dewatering composition.

Optionally, other additives may be included in the present compositions comprising solvents and surfactants for use in dewatering. Such additives include compounds having antistatic properties; the ability to dissipate static charge from non-conductive substrates such as glass and silica. Use of an antistatic additive in the dewatering compositions of the present invention may be necessary to prevent spots and stains when drying water or aqueous solutions from electrically non-conductive parts such as glass lenses and mirrors. Most unsaturated fluoroether solvents of the present invention also have utility as dielectric fluids, i.e., they are poor conductors of electric current and do not easily dissipate static charge.

Boiling and general circulation of dewatering compositions in conventional drying and cleaning equipment can create static charge, particularly in the latter stages of the drying process where most of the water has been removed from a substrate. Such static charge collects on non-conductive surfaces of the substrate and prevents the release of water from the surface. The residual water dries in place resulting in undesirable spots and stains on the substrate. Static charge remaining on substrates can bring out impurities from the cleaning process or can attract impurities such as lint from the air, which results in unacceptable cleaning performance.

In one embodiment, desirable antistatic additives are polar compounds, which are soluble in the present unsaturated fluorinated ether solvent and result in an increase in the conductivity of the unsaturated fluorinated ether solvent resulting in dissipation of static charge from a substrate. In another embodiment, the antistatic additives have a normal boiling point near that of the unsaturated fluorinated ether solvent and have minimal to no solubility in water. In yet another embodiment, the antistatic additives have a solubility in water of less than about 0.5 weight percent. In one embodiment, the solubility of antistatic agent is at least 0.5 weight percent in unsaturated fluorinated ether solvent. In one embodiment, the antistatic additive is nitromethane (CH₃NO₂).

In one embodiment, the dewatering composition containing an antistatic additive is effective in both the dewatering and drying and rinse steps of a method to dewater or dry a substrate as described below.

Another embodiment relates to a method for dewatering or drying a substrate comprising:
a) contacting the substrate with a composition comprising a solvent, wherein the solvent comprises an azeotropic or azeotrope-like composition of perfluoroheptene and a fluorinated ether selected from 1,1,2,2-tetrafluoroethyl-2,2,2-trifluoroethyl ether, nonafluorobutyl methyl ether and nonafluorobutyl ethyl ether, containing surfactant, thereby dewatering the substrate; and
b) recovering the dewatered substrate from the composition.

In one embodiment, the surfactant for dewatering and drying is soluble to at least 1 weight percent based on the total solvent/surfactant composition weight. In another embodiment, the dewatering or drying method of the present disclosure is very effective in displacing water from a broad range of substrates including metals, such as tungsten, copper, gold, beryllium, stainless steel, aluminum alloys, brass and the like; from glasses and ceramic surfaces, such as glass, sapphire, borosilicate glass, alumina, silica such as silicon wafers used in electronic circuits, fired alumina and the like; and from plastics such as polyolefin (“Alathon”, Rynite®, “Tenite”), polyvinylchloride, polystyrene (Styron), polytetrafluoroethylene (Teflon®), tetrafluoroethylene-ethylene copolymers (Tefzel®), polyvinylidenefluoride (“Kynar”), ionomers (Surlyn®), acrylonitrile-butadiene-styrene polymers (Kralac©), phenol-formaldehyde copolymers, cellulosic (“Ethocel”), epoxy resins, polyacetal (Delrin®), poly(p-phenylene oxide) (Noryl®), polyetherketone (“Ultrapek”), polyetheretherketone (“Victrex”), poly(butylene terephthalate) (“Valox”), polyarylate (Arylon®), liquid crystal polymer, polyimide (Vespel®), polyetherimides (“Ultem”), polyamideimides (“Torlon”), poly(p-phenylene sulfide) (“Rython”), polysulfone (“Udel”), and polyaryl sulfone (“Rydel”). In another embodiment, the compositions for use in the present dewatering or drying method are compatible with elastomers.

In one embodiment, the disclosure is directed to a process for removing at least a portion of water from the surface of a wetted substrate (dewatering), which comprises contacting the substrate with the aforementioned dewatering composition, and then removing the substrate from contact with the dewatering composition. In another embodiment, water originally bound to the surface of the substrate is displaced by solvent and/or surfactant and leaves with the dewatering composition. As used herein, the term “at least a portion of water” means at least about 75 weight percent of water at the surface of a substrate is removed per immersion cycle. As used herein, the term “immersion cycle” means one cycle involving at least a step wherein substrate is immersed in the present dewatering composition.

Optionally, minimal amounts of surfactant remaining adhered to the substrate can be further removed by contacting the substrate with surfactant-free halocarbon solvent. Holding the article in the solvent vapor or refluxing solvent will further decrease the presence of surfactant remaining on the substrate. Removal of solvent adhering to the surface of the substrate is affected by evaporation. Evaporation of solvent at atmospheric or subatmospheric pressures can be employed and temperatures above and below the boiling point of the halocarbon solvent can be used.

Methods of contacting the substrate with dewatering composition are not critical and can vary widely. For example, the substrate can be immersed in the composition, or the substrate can be sprayed with the composition using conventional equipment. Complete immersion of the substrate is preferred as it generally insures contact between the composition and all exposed surfaces of the substrate. However, any other method, which can easily provide such complete contact may be used.

The time period over which substrate and dewatering composition are contacted can vary widely. Usually, the contacting time is up to about 5 minutes, however, longer times may be used if desired. In one embodiment of the dewatering process, the contacting time is from about 1 second to about 5 minutes. In another embodiment, the contacting time of the dewatering process is from about 15 seconds to about 4 minutes.

Contacting temperatures can also vary widely depending on the boiling point of the composition. In general, the contacting temperature is equal to or less than the composition's normal boiling point.

In one embodiment, the compositions of the present disclosure may further contain a co-solvent. Such co-solvents are desirable where the present compositions are employed in cleaning conventional process residue from substrates, e.g., removing soldering fluxes and degreasing mechanical components comprising substrates of the present invention. Such co-solvents include alcohols (such as methanol, ethanol, isopropanol), ethers (such as diethyl ether, methyl tertiary-butyl ether), ketones (such as acetone), esters (such as ethyl acetate, methyl dodecanoate, isopropyl myristate and the dimethyl or diisobutyl esters of succinic, glutaric or adipic acids or mixtures thereof), ether alcohols (such as propylene glycol monopropyl ether, dipropylene glycol monobutyl ether, and tripropylene glycol monomethyl ether), and hydrocarbons (such as pentane, cyclopentane, hexane, cyclohexane, heptane, octane), and hydrochlorocarbons (such as trans-1,2-dichloroethylene). When such a co-solvent is employed with the present composition for substrate dewatering or cleaning, it may be present in an amount of from about 1 weight percent to about 50 weight percent based on the weight of the overall composition.

The method for cleaning a surface may be applied to the same types of surfaces as the method for deposition as described below. Semiconductor surfaces or magnetic media disks of silica, glass, metal or metal oxide, or carbon may have contaminants removed by the process of the invention. In the method described above, contaminant may be removed from a disk by contacting the disk with the cleaning composition and recovering the disk from the cleaning composition.

In yet another embodiment, the present method also provides methods of removing contaminants from a product, part, component, substrate, or any other article or portion thereof by contacting the article with a cleaning composition of the present disclosure. As referred to herein, the term “article” refers to all such products, parts, components, substrates, and the like and is further intended to refer to any surface or portion thereof.

As used herein, the term “contaminant” is intended to refer to any unwanted material or substance present on the article, even if such substance is placed on the article intentionally. For example, in the manufacture of semiconductor devices it is common to deposit a photoresist material onto a substrate to form a mask for the etching operation and to subsequently remove the photoresist material from the substrate. The term “contaminant,” as used herein, is intended to cover and encompass such a photo resist material. Hydrocarbon based oils and greases and dioctylphthalate are examples of the contaminants that may be found on the carbon coated disks.

In one embodiment, the method of the invention comprises contacting the article with a cleaning composition of the invention, in a vapor degreasing and solvent cleaning method. In one such embodiment, vapor degreasing and solvent cleaning methods consist of exposing an article, preferably at room temperature, to the vapors of a boiling cleaning composition. Vapors condensing on the object have the advantage of providing a relatively clean, distilled cleaning composition to wash away grease or other contamination. Such processes thus have an additional advantage in that final evaporation of the present cleaning composition from the object leaves behind relatively little residue as compared to the case where the object is simply washed in liquid cleaning composition.

In another embodiment, for applications in which the article includes contaminants that are difficult to remove, the method of the invention involves raising the temperature of the cleaning composition above ambient temperature or to any other temperature that is effective in such application to substantially improve the cleaning action of the cleaning composition. In one such embodiment, such processes are also generally used for large volume assembly line operations where the cleaning of the article, particularly metal parts and assemblies, must be done efficiently and quickly.

In one embodiment, the cleaning methods of the present disclosure comprise immersing the article to be cleaned in liquid cleaning composition at an elevated temperature. In another embodiment, the cleaning methods of the present disclosure comprise immersing the article to be cleaned in liquid cleaning composition at about the boiling point of the cleaning composition. In one such embodiment, this step removes a substantial amount of the target contaminant from the article. In yet another embodiment, this step removes a major portion of the target contaminant from the article. In one embodiment, this step is then followed by immersing the article in freshly distilled cleaning composition, which is at a temperature below the temperature of the liquid cleaning composition in the preceding immersion step. In one such embodiment, the freshly distilled cleaning composition is at about ambient or room temperature. In yet another embodiment, the method also includes the step of then contacting the article with relatively hot vapor of the cleaning composition by exposing the article to vapors rising from the hot/boiling cleaning composition associated with the first mentioned immersion step. In one such embodiment, this results in condensation of the cleaning composition vapor on the article. In certain preferred embodiments, the article may be sprayed with distilled cleaning composition before final rinsing.

It is contemplated that numerous varieties and types of vapor degreasing equipment are adaptable for use in connection with the present methods. One example of such equipment and its operation is disclosed by U.S. Pat. No. 3,085,918, which is incorporated herein by reference. The equipment disclosed therein includes a boiling sump for containing a cleaning composition, a clean sump for containing distilled cleaning composition, a water separator, and other ancillary equipment.

The present cleaning methods may also comprise cold cleaning in which the contaminated article is either immersed in the fluid cleaning composition of the present disclosure under ambient or room temperature conditions or wiped under such conditions with rags or similar objects soaked in the cleaning composition.

Another embodiment relates to a method of depositing a fluorolubricant on a surface comprising: (a) combining at least one fluorolubricant and a solvent, said solvent comprising an azeotropic or azeotrope-like composition of perfluoroheptene and a fluorinated ether selected from 1,1,2,2-tetrafluoroethyl-2,2,2-trifluoroethyl ether, nonafluorobutyl methyl ether and nonafluorobutyl ethyl ether, to form a lubricant-solvent combination; (b) contacting the combination of lubricant-solvent with the surface; and (c) evaporating the solvent from the surface to form a fluorolubricant coating on the surface.

In one embodiment of the invention, the fluorolubricants of the present disclosure comprise perfluoropolyether (PFPE) compounds, or a lubricant comprising X-1P®, which is a phosphazene-containing disk lubricant. These perfluoropolyether compounds are sometimes referred to as perfluoroalkylethers (PFAE) or perfluoropolyalkylethers (PFPAE). These PFPE compounds range from simple perfluorinated ether polymers to functionalized perfluorinated ether polymers. PFPE compounds of different varieties that may be useful as fluorolubricant in the present disclosure are available from several sources.

In another embodiment, useful fluorolubricants for the present inventive method include but are not limited to Krytox© GLP 100, GLP 105 or GLP 160 (E. I. du Pont de Nemours & Co., Fluoroproducts, Wilmington, DE, 19898, USA); Fomblin® Z-Dol 2000, 2500 or 4000, Z-Tetraol, or Fomblin® AM 2001 or AM 3001 (sold by Solvay Solexis S.p.A., Milan, Italy); Demnum™ LR-200 or S-65 (offered by Daikin America, Inc., Osaka, Japan); X-1P® (a partially fluorinated hyxaphenoxy cyclotriphosphazene disk lubricant available from Quixtor Technologies Corporation, a subsidiary of Dow Chemical Co, Midland, MI); and mixtures thereof.

The Krytox® lubricants are perfluoroalkylpolyethers having the general structure F(CF(CF₃)CF₂O)ₙ—CF₂CF₃, wherein n ranges from 10 to 60. The Fomblin® lubricants are functionalized perfluoropolyethers that range in molecular weight from 500 to 4000 atomic mass units and have general formula X—CF₂—O(CF₂—CF₂—O)ₚ—(CF₂O)_{q}—CF₂—X, wherein X may be —CH₂OH, CH₂(O—CH₂—CH₂)ₙOH, CH₂OCH₂CH(OH)CH₂OH or —CH₂O—CH₂-piperonyl. The Demnum™ oils are perfluoropolyether-based oils ranging in molecular weight from 2700 to 8400 atomic mass units. Additionally, new lubricants are being developed such as those from Moresco (Thailand) Co., Ltd, which may be useful in the present inventive method.

The fluorolubricants of the present disclosure may additionally comprise additives to improve the properties of the fluorolubricant. X-1P®, which may serve as the lubricant itself, is often added to other lower cost fluorolubricants in order to increase the durability of disk drives by passivating Lewis acid sites on the disk surface responsible for PFPE degradation. Other common lubricant additives may be used in the fluorolubricants of the present inventive methods.

The fluorolubricants of the present disclosure may further comprise Z-DPA (Hitachi Global Storage Technologies, San Jose, CA), a PFPE terminated with dialkylamine end-groups. The nucleophilic end-groups serve the same purpose as X1P®, thus providing the same stability without any additive.

The surface on which the fluorolubricant may be deposited is any solid surface that may benefit from lubrication. Semiconductor materials such as silica disks, metal or metal oxide surfaces, vapor deposited carbon surfaces or glass surfaces are representative of the types of surfaces for which the methods of the present disclosure are useful. The present inventive method is particularly useful in coating magnetic media such as computer drive hard disks. In the manufacture of computer disks, the surface may be a glass, or aluminum substrate with layers of magnetic media that is also coated by vapor deposition with a thin (10-50 Angstrom) layer of amorphous hydrogenated or nitrogenated carbon. The fluorolubricant may be deposited on the surface disk indirectly by applying the fluorolubricant to the carbon layer of the disk.

The first step of combining at least one fluorolubricant and solvent (“fluorolubricant/solvent combination”) may be accomplished in any suitable manner such as mixing in a suitable container such as a beaker or other container that may be used as a bath for the deposition method. The fluorolubricant concentration in the azeotropic solvent may be from about 0.010 percent (wt/wt) to about 0.50 percent (wt/wt).

The step of contacting the fluorolubricant/solvent combination with the surface may be accomplished in any manner appropriate for the surface, based on the size and shape of the surface. A hard drive disk must be supported in some manner such as with a mandrel or some other support that may fit through the hole in the center of the disk. The disk will thus be held vertically such that the plane of the disk is perpendicular to the solvent bath. The mandrel may have different shapes including, but not limited to, a cylindrical bar, or a V-shaped bar. The mandrel shape will determine the area of contact with the disk. The mandrel may be constructed of any material strong enough to hold the disk, including but not limited to metal, metal alloy, plastic or glass. Additionally, a disk may be supported vertically upright in a woven basket or be clamped into a vertical position with 1 or more clamps on the outer edge. The support may be constructed of any material with the strength to hold the disk, such as metal, metal alloy, plastic or glass. However, the disk is supported, the disk will be lowered into a container holding a bath of the fluorolubricant/solvent combination. The bath may be held at room temperature or be heated or cooled to temperatures ranging from about 0° C. to about 50° C.

Alternatively, the disk may be supported as described above and the bath may be raised to immerse the disk. In either case, the disk may then be removed from the bath, either by lowering the bath or by raising the disk. Excess fluorolubricant/solvent combination can be drained into the bath.

Either of the methods for contacting the fluorolubricant/solvent combination with the disk surface of either lowering the disk into a bath or raising a bath to immerse the disk are commonly referred to as dip coating. Other methods for contacting the disk with the fluorolubricant/solvent combination may be used in the present disclosure, including spraying or spin coating.

When the disk is removed from the bath, the disk will have a coating of fluorolubricant and some residual solvent (unsaturated fluorinated ether) on its surface. The residual solvent may be evaporated. Evaporation is usually performed at room temperature. However, other temperatures both above and below room temperature may be used as well for the evaporation step. Temperatures ranging from about 0° C. to about 100° C. may be used for evaporation.

The surface, or the disk if the surface is a disk, after completion of the coating method, will be left with a substantially uniform or uniform coating of fluorolubricant that is substantially free of solvent. The fluorolubricant may be applied to a thickness of less than about 300 nm, and alternately to a thickness of about 100 to about 300 nm.

A uniform fluorolubricant coating is desired for proper functioning of a disk and so areas of varying fluorolubricant thickness are undesirable on the surface of the disk. As more and more information is being stored on the same size disk, the read/write head must get closer and closer to the disk in order to function properly. If irregularities due to variation in coating thickness are present on the surface of the disk, the probability of contact of the head with these areas on the disk is much greater. While there is a desire to have enough fluorolubricant on the disk to flow into areas where it may be removed by head contact or other means, coating that is too thick may cause “smear,” a problem associated with the read/write head picking up excess fluorolubricant.

One specific coating thickness irregularity observed in the industry is that known as the “rabbit ears” effect. These irregularities are visually detected on the surface of the disk after deposition of the fluorolubricant using the existing solvent systems. When the disk is contacted with the solution of fluorolubricant in solvent and then removed from the solution, any points where the solution may accumulate and not drain readily develop drops of solution that do not readily drain off. One such point of drop formation is the contact point (or points) with the mandrel or other support device with the disk. When a V-shaped mandrel is used, there are two contact points at which the mandrel contacts the inside edge of the disk. When solution of fluorolubricant forms drops in these locations that do not drain off when removed from the bath, an area of greater thickness of fluorolubricant is created when the solvent evaporates. The two points of contact with the disk produces what is known as a “rabbit ears” effect, because the areas of greater fluorolubricant thickness produce a pattern resembling rabbit ears visually detectable on the disk surface.

When dip coating is used for depositing fluorolubricant on the surface, the pulling-up speed (speed at which the disk is removed from the bath), and the density of the fluorolubricant and the surface tension are relevant for determining the resulting film thickness of the fluorolubricant. Awareness of these parameters for obtaining the desired film thickness is required. Details on how these parameters affect coatings are given in, “Dip-Coating of Ultra-Thin Liquid Lubricant and its Control for Thin-Film Magnetic Hard Disks” in IEEE Transactions on Magnetics, vol. 31, no. 6, November 1995.

While the invention has been described with reference to one or more embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

### EXAMPLES

The concepts described herein will be further described in the following examples, which do not limit the scope of the invention described in the claims. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative, rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

### Example 1—Boiling Point Depression of PFH with HFE-347pcF

An ebulliometer apparatus was used to determine the azeotrope-like range of the perfluoroheptene and 1,1,2,2-tetrafluoroethyl-2,2,2-trifluoroethyl ether (HFE-347pcF) mixtures. The apparatus consisted of a flask with thermocouple, heating mantle and condenser. A side neck on the flask was fitted with a rubber septum to allow the addition of one component into the flask. Initially the flask contained 100% perfluoroheptene and the liquid was heated gradually until reflux and the boiling temperature was recorded to the nearest 0.1 deg C. Additions of HFE-347pcF were made into the flask through the side neck, at approximately 1 wt % increments. Each time an addition of HFE-347pcF was made, the flask boiling temperature was allowed to stabilize and then recorded. The HFE-347pcF was added to the perfluoroheptene mixture in the flask until a composition of approximately 50 wt % HFE-347pcF and 50 wt % perfluoroheptene was present. A similar experiment began with 100% HFE-347pcF in the flask and perfluoroheptene was then added incrementally added to the flask, to again obtain about 50% HFE-347pcF and 50% perfluoroheptene. In this way, the boiling temperatures of HFE-347pcF and perfluroheptene mixtures from 0 to 100% were obtained. The results are presented in Table 4.

TABLE 4

| % wt PFH | BP (° C.) |
|---|---|
| 0.0% | 56.3 |
| 6.1% | 55.9 |
| 12.7% | 55.6 |
| 16.8% | 55.5 |
| 24.1% | 55 |
| 31.7% | 54.9 |
| 38.0% | 54.9 |
| 44.0% | 54.9 |
| 47.8% | 54.9 |
| 52.1% | 55.1 |
| 56.3% | 55.6 |
| 61.1% | 56.1 |
| 65.3% | 56.4 |
| 68.5% | 56.7 |
| 73.4% | 57.7 |
| 74.8% | 58 |
| 100.0% | 71.5 |

The data indicate a minimum boiling point of 54.9° C. for compositions of from 31.7 to 47.8 wt % of PFH.

### Example 2: Boiling Point Depression of PFH with Novec 7100

An ebulliometer apparatus was used to determine the azeotrope-like range of the perfluoroheptene and Novec 7100 mixtures. The apparatus consisted of a flask with thermocouple, heating mantle and condenser. A side neck on the flask was fitted with a rubber septum to allow the addition of one component into the flask. Initially the flask contained 100% perfluoroheptene and the liquid was heated gradually until reflux and the boiling temperature was recorded to the nearest 0.1 deg C. Additions of Novec 7100 were made into the flask through the side neck, at approximately 1 wt % increments. Each time an addition of Novec 7100 was made, the flask boiling temperature was allowed to stabilize and then recorded. The Novec 7100 was added to the perfluoroheptene mixture in the flask until a composition of approximately 50 wt % Novec 7100 and 50 wt % perfluoroheptene was present. A similar experiment began with 100% Novec 7100 in the flask and perfluoroheptene was then added incrementally added to the flask, to again obtain about 50% Novec 7100 and 50% perfluoroheptene. In this way, the boiling temperatures of Novec 7100 and perfluoroheptene mixtures from 0 to 100% were obtained. The results are presented in Table 5.

TABLE 5

| % wt PFH | BP (° C.) |
|---|---|
| 0.0 | 59.9 |
| 0.9 | 59.9 |
| 2.8 | 59.9 |
| 5.8 | 59.9 |
| 10.1 | 59.9 |
| 13.9 | 60.1 |
| 20.5 | 60.2 |
| 27.3 | 60.5 |
| 40.3 | 60.8 |
| 50.8 | 61.9 |
| 57.1 | 62.7 |
| 70.8 | 63.8 |
| 75.9 | 65.4 |
| 85.8 | 66.5 |
| 93.8 | 68.3 |
| 96.6 | 69.5 |
| 100.0 | 70.9 |

The data indicate a minimum boiling point of 59.9° C. for compositions of from 0.9 to 10.1 wt % of PFH.

### Example 3—Boiling Point Depression of PFH with Novec 7200

An ebulliometer apparatus was used to determine the azeotrope-like range of the perfluoroheptene and Novec 7200 mixtures. The apparatus consisted of a flask with thermocouple, heating mantle and condenser. A side neck on the flask was fitted with a rubber septum to allow the addition of one component into the flask. Initially the flask contained 100% Novec 7200 and the liquid was heated gradually until reflux and the boiling temperature was recorded to the nearest 0.1 deg C. Additions of perfluoroheptene were made into the flask through the side neck, at approximately 1 wt % increments. Each time an addition of perfluoroheptene was made, the flask boiling temperature was allowed to stabilize and then recorded. The perfluoroheptene was added to the Novec 7200 mixture in the flask until a composition of approximately 50 wt % perfluoroheptene and 50 wt % Novec 7200. A similar experiment began with 100% perfluoroheptene in the flask and Novec 7200 was then added incrementally added to the flask, to again obtain about 50% perfluoroheptene and 50% Novec 7200. In this way, the boiling temperatures of perfluoroheptene and Novec 7200 mixtures from 0 to 100% were obtained. The results are presented in Table 6. The data show a minimum in temperature at 69.9° C., which indicates that an azeotrope has been formed. The bubble point temperature of the mixture remains constant indicating that this mixture is azeotrope-like over a large composition range.

TABLE 6

| % wt Novec 7200 | BP (° C.) |
|---|---|
| 0.0 | 71.1 |
| 0.3 | 70.9 |
| 1.3 | 70.8 |
| 3.3 | 70.6 |
| 6.6 | 70.3 |
| 10.3 | 70.1 |
| 15.2 | 69.9 |
| 20.5 | 69.9 |
| 25.7 | 70.1 |
| 32.2 | 70.3 |
| 38.7 | 70.7 |
| 46.5 | 71.3 |
| 54.5 | 71.9 |
| 64.0 | 72.8 |
| 73.6 | 73.4 |
| 81.4 | 74.1 |
| 100.0 | 76 |

The data indicate a minimum boiling point of 69.9° C. for compositions of from 15.2 to 20.5 wt % of PFH.

### Example 4

The azeotropic or azeotrope-like mixtures were used to remove oil from surfaces as described in the example below.

An azeotropic compositions of perfluoroheptene and the indicated amount of fluoroether were prepared. Preweighed cover glass samples (size approximately 32×18 mm) were coated with about 20 mg of mineral oil using a swab. The coupons were weighed and submerged into the solvent in an ultrasonic cleaner at room temperature for one minute. The glasses were removed from the solvent, allowed to air dry for 1 minute, then weighed a final time. The % of oil removed was calculated to demonstrate cleaning effectiveness.

Table 7 shows that the azeotrope-like mixtures were effective in removing the oil from the coupons.

TABLE 7

| | | Percent Contamination |
|---|---|---|
| Co-solvent | PFH Content | Removed |
| Novec 7200 | 80% | 94% |
| HFE-347pcF | 40% | 97% |
| Novec 7100 | 50% | >99% |
| None | 100% | 50% |

### Example 5—PFPE Lubricant Solubility

The Solubility of Fomblin T4 PFPE lubricant from Solvay was determined gravimetrically at room temperature. A glass vial was weighed to four decimal places using a laboratory balance. A known amount of lubricant was added to the vial and the mass was recorded. Each solvent was added in known increments until the lubricant was completely dissolved. Once dissolved, the gross weight of the container was measured, and the mass of the solvent/lubricant mixture was calculated by subtracting the weight of the empty vial. The solubility limit was calculated as the weight of the lubricant divided by the weight of the solvent/lubricant mixture and is expressed as the maximum weight percent of lubricant completely soluble in the given solvent.

TABLE 8

| Solvent | Solubility of Fomblin ™ T4 |
|---|---|
| Perfluoroheptene | <0.5% |
| HFE-347pcf | 1.5% |
| 48% PFH/ 52% HFE-347pcf | >10% |

As shown in Table 8 above, mixtures of PFH and HFE-347pcf demonstrated better solubility of the lubricant than the pure components.

1. An azeotropic or azeotrope-like composition comprising perfluoroheptene and a fluorinated ether selected from 1,1,2,2-tetrafluoroethyl-2,2,2-trifluoroethyl ether, nonafluorobutyl methyl ether and nonafluorobutyl ethyl ether.

2. The azeotropic composition of claim 1, comprising from about 31.7 weight percent to about 47.8 weight percent perfluoroheptene, and from 52.2 weight percent to about 68.3 weight percent 1,1,2,2-tetrafluoroethyl-2,2,2-trifluoroethyl ether.

3. The azeotrope-like composition of claim 1, comprising from about 6.1 weight percent to about 61.1 weight percent perfluoroheptene, and from about 38.9 weight percent to about 93.9 weight percent 1,1,2,2-tetrafluoroethyl-2,2,2-trifluoroethyl ether.

4. The azeotrope-like composition of claim 1, comprising from about 16.8 weight percent to about 56 weight percent perfluoroheptene, and from about 44 weight percent to about 83.2 weight percent 1,1,2,2-tetrafluoroethyl-2,2,2-trifluoroethyl ether.

5. The azeotrope-like composition of claim 1, comprising from about 24 weight percent to about 52 weight percent perfluoroheptene, and from about 48 weight percent to about 76 weight percent 1,1,2,2-tetrafluoroethyl-2,2,2-trifluoroethyl ether.

6. The azeotropic composition of claim 1 comprising from about 0.9 weight percent to about 10.1 weight percent perfluoroheptene, and from 89.9 weight percent to about 99.1 weight percent nonafluorobutyl methyl ether.

7. The azeotrope-like composition of claim 1, comprising from about 0.9 weight percent to about 40.3 weight percent perfluoroheptene, and from about 59.7 weight percent to about 99.1 weight percent nonafluorobutyl methyl ether.

8. The azeotrope-like composition of claim 1, comprising from about 0.9 weight percent to about 27.3 weight percent perfluoroheptene, and from about 72.7 weight percent to about 99.1 weight percent nonafluorobutyl methyl ether.

9. The azeotrope-like composition of claim 1, comprising from about 0.9 weight percent to about 14 weight percent perfluoroheptene, and from about 86 weight percent to about 99.1 weight percent nonafluorobutyl methyl ether.

10. The azeotropic composition of claim 1 comprising from about 79.5 weight percent to about 84.8 weight percent perfluoroheptene, and from 15.2 weight percent to about 20.5 weight percent nonafluorobutyl ethyl ether.

11. The azeotrope-like composition of claim 1, comprising from about 61.3 weight percent to about 99.7 weight percent perfluoroheptene, and from about 0.3 weight percent to about 38.7 weight percent nonafluorobutyl ethyl ether.

12. The azeotrope-like composition of claim 1, comprising from about 67.8 weight percent to about 93.4 weight percent perfluoroheptene, and from about 6.6 weight percent to about 32.2 weight percent nonafluorobutyl ethyl ether.

13. The azeotrope-like composition of claim 1, comprising from about 74.3 weight percent to about 89.5 weight percent perfluoroheptene, and from about 10.5 weight percent to about 25.7 weight percent nonafluorobutyl ethyl ether.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. An immersion cooling unit comprising:
an immersion cell, defining an internal cavity;
i) an electronic component in the internal cavity;
ii) a dielectric working fluid partially filling the internal cavity;
iii) a condensing coil, positioned in the internal cavity above the electronic component;
wherein the dielectric working fluid at least partially immerses the electronic component; and
wherein the dielectric working fluid includes an azeotropic or azeotrope-like composition comprising perfluoroheptene and a fluorinated ether selected from 1,1,2,2-tetrafluoroethyl-2,2,2-trifluoroethyl ether, nonafluorobutyl methyl ether and nonafluorobutyl ethyl ether.

31. The immersion cooling unit of claim 30, wherein the dielectric working fluid does not immerse the condensing coil.

32. The immersion cooling unit of claim 30, wherein an operating temperature range is between 40° C. and 80° C.

33. The immersion cooling unit of claim 32, wherein the operating temperature range is between 50° C. and 70° C.

34. The immersion cooling unit of claim 30, wherein the volume resistivity of the dielectric working fluid is at least 1×10¹⁰.

35. The immersion cooling unit of claim 30, wherein the volume resistivity of the dielectric working fluid is at least 1×10¹¹.

36. The immersion cooling unit of claim 30, wherein the volume resistivity of the dielectric working fluid is at least 1×10¹².

37. The immersion cooling unit of claim 30, wherein the dielectric working fluid has a global warming potential (GWP) of less than 500.

38. The immersion cooling unit of claim 30, wherein the electronic component is one of: microprocessors, wafers used to manufacture semiconductor devices, power control semiconductors, electrical distribution switch gear, power transformers, circuit boards, multi-chip modules, packaged and unpackaged semiconductor devices, laser, fuel cells and electrochemical cells.

39. The immersion cooling unit of claim 30, wherein the dielectric working fluid comprises the azeotropic mixture of from about 31.7 weight percent to about 47.8 weight percent perfluoroheptene, and from 52.2 weight percent to about 68.3 weight percent 1,1,2,2-tetrafluoroethyl-2,2,2-trifluoroethyl ether

40. The immersion cooling unit of claim 30, wherein the dielectric working fluid comprises the azeotope-like mixture of from about 16.8 weight percent to about 56 weight percent perfluoroheptene, and from about 44 weight percent to about 83.2 weight percent 1,1,2,2-tetrafluoroethyl-2,2,2-trifluoroethyl ether.

41. A method for cooling an electrical component comprising:
at least partially immersing an electrical component in a working fluid; and
transferring heat from the electrical component using the working fluid;
wherein the working fluid comprises an azeotropic or azeotrope-like composition comprising perfluoroheptene and a fluorinated ether selected from 1,1,2,2-tetrafluoroethyl-2,2,2-trifluoroethyl ether, nonafluorobutyl methyl ether and nonafluorobutyl ethyl ether.

42. The method of claim 41, where said transferring of heat occurs through pumping of said working fluid from the electrical component to be cooled to a remote heat sink.

43. The method of claim 42, where said transferring of heat occurs through vaporization of said working fluid in contact with the electrical component to be cooled, and condensing said working fluid vapor through contact with a heat sink.

44. A method of replacing a high-GWP dielectric fluid in an immersion cooling system, comprising:
charging an immersion cooling system that was designed for use with a perfluorinated working fluid with a composition comprising an azeotropic or azeotrope-like composition comprising perfluoroheptene and a fluorinated ether selected from 1,1,2,2-tetrafluoroethyl-2,2,2-trifluoroethyl ether, nonafluorobutyl methyl ether and nonafluorobutyl ethyl ether.

45. The method of claim 44, wherein the electrical component to fluid thermal resistance of the replacement fluid is lower than or equivalent to said perfluorinated working fluid,

46. The method of claim 44, wherein the electrical component to fluid thermal resistance of the replacement fluid is no higher than 20% greater than that of said perfluorinated working fluid.

47. The method of claim 44, wherein the electrical component to fluid thermal resistance of the replacement fluid is no higher than 10% greater than that of said perfluorinated working fluid.
